(19) United States
(12) Patent Application Publication
(10) Pub. No.: US 2017/0197564 A1
(43) Pub. Date: Jul. 13, 2017

(54) PIPE INSTALLATION COMPONENT, AND STRUCTURE OF END PORTION OF PIPE

(71) Applicant: SUMITOMO WIRING SYSTEMS, LTD., Yokkaichi (JP)

(72) Inventors: Masahiro HAGI, Yokkaichi (JP); Hiroshi INOUE, Yokkaichi (JP)

(73) Assignee: SUMITOMO WIRING SYSTEMS, LTD., Yokkaichi (JP)

(21) Appl. No.: 15/394,519

(22) Filed: Dec. 29, 2016

(30) Foreign Application Priority Data
Jan. 12, 2016 (JP) 2016-003282

(51) Int. Cl. B60R 16/02; H02G 3/04; F16L 35/00

(52) U.S. Cl. CPC B60R 16/0215; F16L 35/00; H02G 3/0481; B60Y 2410/115

(57) ABSTRACT

A pipe installation component includes (i) a protection portion that covers an end surface of a pipe and (ii) a waterproofing portion that has an electric wire insertion hole that seals to an outer circumferential surface of an electric wire inserted through the pipe 30. The waterproofing portion seals to an entire circumference of an end portion of the pipe, and seals the end portion of the pipe. The electric wire can be protected from the end surface of the pipe, and the pipe can be waterproofed, using a single component.

### BACKGROUND

This invention relates to a pipe installation component that is installed at an end portion of a pipe, and a structure of the end portion of the pipe.

It is conventionally known to protect electric wires of a wire harness that is arranged in a vehicle or the like by inserting the wires through the inside of a pipe, or the like. As disclosed in, for example, JP-A-2015-35915, a holder that is a resin molded product is installed at an end portion of this type of pipe, and the holder suppresses the electric wires from contacting an end periphery of the pipe. By so doing, damage or the like to coverings of the electric wires due to the electric wires contacting the end periphery of the pipe can be suppressed. Additionally, as disclosed in, for example, JP-A-2015-80340, a grommet is installed at an end portion of this type of pipe, so entrance of water to the inside of the pipe can be suppressed. Thus, it is possible to suppress water from freezing in the pipe at a low temperature after water enters the inside of the pipe, so as not to damage coverings of the electric wires or the like.

### SUMMARY

However, in the above structure, a component for protecting electric wires and a component for suppressing water from entering a pipe are separately needed. To realize weight reduction, cost reduction, and the like, there has been a request for reducing the number of components that are installed at an end portion of a pipe.

Embodiments of the invention address the above situation. An object of embodiments of this invention is to provide a pipe installation component and a structure of an end portion of a pipe that can protect electric wires and waterproof the pipe using only one component.

A pipe installation component of an embodiment of this invention is provided with (i) a protection portion that covers an end surface of a pipe and (ii) a waterproofing portion that has one or more electric wire insertion holes that seal to respective outer circumferential surfaces of one or more electric wires inserted through the pipe, and seals to an entire circumference of an end portion of the pipe and seals the end portion of the pipe. According to the structure of an end portion of a pipe of an embodiment of this invention, the pipe installation component is installed at the end portion of the pipe.

According to embodiments of this invention, the protection portion can suppress an electric, wire from contacting an edge of the pipe, and the waterproofing portion can suppress water from entering the inside of the pipe. Thus, protection of one or more electric wires, and waterproofing of the pipe, can be accomplished using only one component.

### BRIEF DESCRIPTION OF The DRAWINGS

FIG. 1 is a cross-sectional view showing a pipe installation component.

FIG. 2 is a cross-sectional view showing a structure of an end portion of a pipe.

### DETAILED DESCRIPTION OF EMBODIMENTS

Exemplary embodiments of this invention are shown below.

For the pipe installation component of an embodiment, it is acceptable that the protection portion is provided with (i) an inner circumferential surface covering portion that covers an inner circumferential surface of an end portion of the pipe and (ii) an outer circumferential surface covering portion that covers an outer circumferential surface of the pipe. According to this structure, not only is the end surface of the pipe covered by the protection portion, but the outer and inner circumferential surfaces are also covered by the protection portion. Thus, this structure can very reliably suppress electric wires from contacting the edge of the pipe.

Additionally, for the pipe installation component of an embodiment, the protection portion can form a tubular shape that can be engaged to the end portion of the pipe, the protection portion and the electric wire insertion holes can be arranged so as to be shifted relative to each other in an axial direction, and inclined portions can be arranged, which are inclined from the protection portion toward the electric wire insertion holes.

Furthermore, the pipe installation component of an embodiment can be constituted such that the protection portion protrudes outward in a diameter direction, in a stepped manner. According to this structure, the end surfaces of the protection portion in the axial direction can be used as references for installation positions of fixing members that fix together (i) the pipe installation component and the pipe and/or (ii) the pipe installation component and the electric wires.

### Embodiments

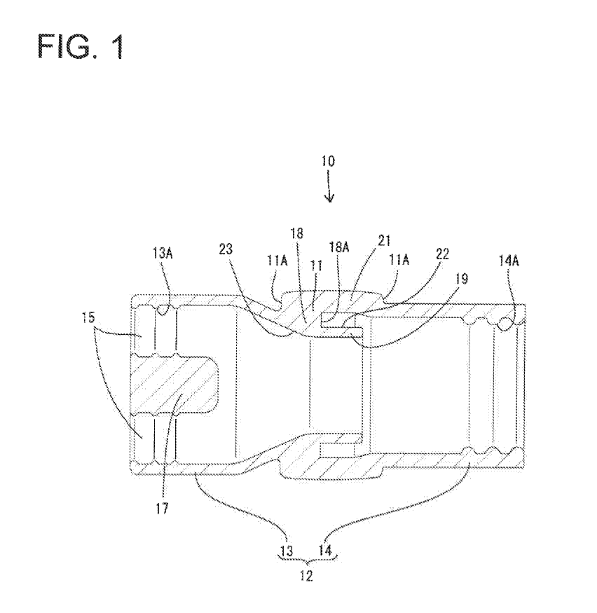

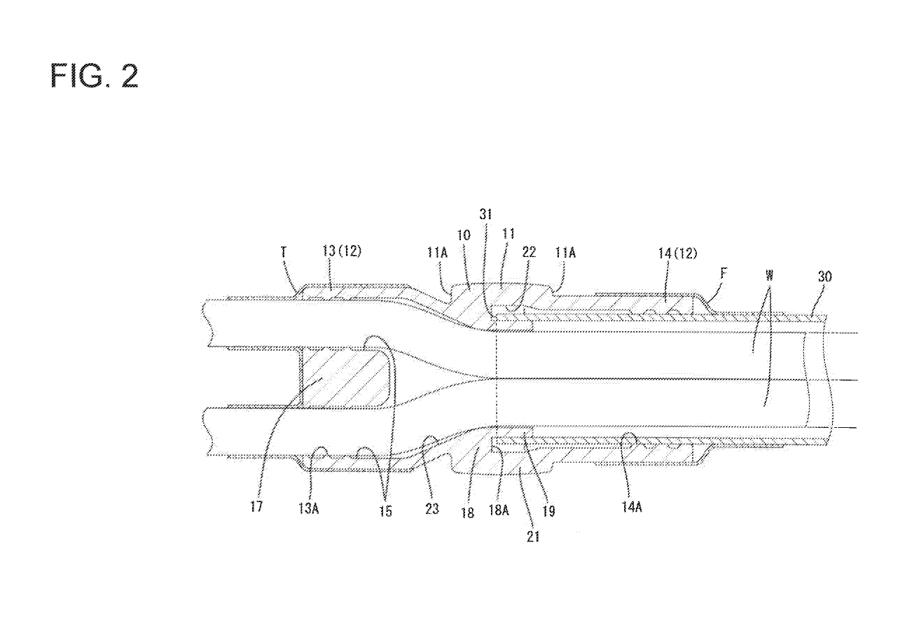

The following explains in detail embodiments that realize this invention, with reference to FIGS. 1 and 2.

A pipe installation component 10 is installed at an end portion of a metal pipe 30. A plurality of electric wires W (two electric wires in this embodiment) of a wire harness that is arranged, e.g., under the floor of a vehicle are inserted through the pipe 30. The pipe 30 may be, for example, aluminum or aluminum alloy, and may be elongate and have a shape that is substantially round in cross-section.

The pipe installation component 10 may be formed integrally from a rubber material that has elasticity. The pipe installation component 10 is provided with (i) a protection portion 11 that suppresses the electric wires W from contacting the edge of the pipe 30 and (ii) a waterproofing portion 12 that suppresses water from entering the inside of the pipe 30. The waterproofing portion 12 is provided with electric wire insertion holes 15 that seal to respective outer circumferential surfaces of the electric wires W inserted through the pipe 30. The waterproofing portion 12 seals to an entire circumference of an end portion of the pipe 30, and seals the end portion of the pipe 30.

The waterproofing portion 12 is provided with a pipe seal portion 14 that externally engages to the end portion of the pipe 30 and can seal to the entire circumference of the outer circumferential surface of the pipe 30. The pipe seal portion 14 may form a substantially cylindrical shape, which adjusts in size to the outer shape of the pipe 30. Lip portions 14A that can seal over the entire circumference of the outer circumferential surface of the pipe 30 are arranged at the inner circumferential surface of the pipe seal portion 14. A plurality of lip portions 14A (three lip portions 14A in this embodiment) may be included, but in some embodiments, a single lip portion may be included, or no lip portions may be included.

The electric wire insertion holes 15 form a round shape in cross section and can seal over the entire surface of the outer circumferential surface of the electric wires W. At the inner circumferential surface of the electric wire insertion holes 15, lip portions 13A are arranged over the entire circumference of the outer circumferential surface of the electric wires W. A plurality of lip portions 13A (three lip portions in this embodiment) may be included, but in some embodiments, a single lip portion may be included, or no lip portions may be included.

The electric wire insertion holes 15 are formed at a portion arranged at a position shifted from the pipe 30 in an axial direction (hereafter referred to as an “electric wire seal portion 13”) in a state in which the pipe installation component 10 is installed at the end portion of the pipe 30, and can seal to the respective outer circumferential surfaces of the electric wires W that extend to the outside from the pipe 30. In the electric seal portion 13, a plurality of the electric wire insertion holes 15 (two electric wire insertion holes in this embodiment) may be formed so as to be aligned at a specified interval in a direction crossing the axial direction.

The electric wire seal portion 13 may form, overall, a long flat shape in a direction in which the electric wire insertion holes 15 are aligned. That is, a dimension of the electric wire seal portion 13 in a left-to-right direction in FIG. 2 may be larger than a dimension of the electric wire seal portion 13 in a direction perpendicular to the plane of the drawing sheet. A partition wall portion 17 is formed between the adjacent electric wire insertion holes 15. A thickness dimension (dimension in a direction in which the electric wire insertion holes 15 are aligned) of the partition wall portion 17 may be, for example, approximately one third the thickness dimension of the end portion of the electric wire seal portion 13 (end portion in the direction in which the electric wire insertion holes 15 are aligned).

The respective electric wire insertion holes 15 may be arranged at positions shifted from the pipe seal portion 14 in an axial direction, and may be arranged at positions shifted outward in the diameter direction from the longitudinal axis of the pipe seal portion 14. The longitudinal axes of the electric wire insertion holes 15 may be substantially parallel to that of the pipe seal portion 14. The two electric wires W that are bundled together and inserted through the inside of the pipe 30 are branched into the respective electric wire insertion holes 15, and extend to the outside. The respective electric wires W in this embodiment extend diagonally outward from the pipe 30 and are inserted through the respective electric wire insertion holes 15.

The protection portion 11 is arranged between the pipe seal portion 14 and the electric wire seal portion 13. The protection portion 11 includes an end surface covering portion 18 that covers an end surface 31 of the pipe 30. The end surface covering portion 18 covers the end surface 31 of the pipe 30 over its entire circumference. The end surface covering portion 18 is provided with a covering surface 18A that is arranged facing the end surface 31 of the pipe 30. The covering surface 18A may be a surface perpendicular to the longitudinal axis of the pipe installation component 10.

The protection portion 11 may include (i) an inner circumferential surface covering portion 19 that covers an inner circumferential surface of the end portion of the pipe 30 and (ii) an outer circumferential surface covering portion 21 that covers an outer circumferential surface of the pipe 30, The inner circumferential surface covering surface 19 forms a tubular shape that can be inserted into the inside of the end portion of the pipe 30, and the outer circumferential surface covering portion 21 forms a tubular shape that can be externally engaged to the end portion of the pipe 30. That is, the protection portion 11 may form double tubular shapes that can be engaged to the end portion of the pipe 30.

A groove portion 22 that opens toward the pipe seal portion 14 side is formed between the inner circumferential surface covering portion 19 and the outer circumferential surface covering portion 21. The groove portion 22 may continue at a constant depth over its entire circumference. The electric wire seal portion 13 side of the groove portion 22 is closed by the end surface covering portion 18.

For the inner circumferential surface covering portion 19 and the outer circumferential surface covering portion 21, a dimension (thickness dimension) in a diameter direction may be constant over the entire circumference. The thickness dimension of the inner circumferential surface covering portion 19 may be smaller (thinner) than that of the outer circumferential surface covering portion 21.

The outer circumferential surface covering portion 21 may be arranged so as to be continuous with the pipe seal portion 14. The thickness dimension of the outer circumferential surface covering portion 21 in the diameter direction may be slightly larger than that of the pipe seal portion 14. The outer circumferential surface covering portion 21 in this embodiment protrudes outward from the pipe seal portion 14 in a stepped manner.

Additionally, the thickness dimension of the end surface covering portion 18 in the axial direction and the thickness dimension of the end surface covering portion 18 in the diameter direction (thickness dimension including a portion connecting the inner circumferential surface covering portion 19 and the outer circumferential surface covering portion 21) are made larger than the thickness dimension of the pipe seal portion 14 in the diameter direction. Thus, the thickness dimensions of the protection portion 11 are made to be relatively larger than those of other portions, so the strength of the protection portion 11 is sufficiently high.

At the inner circumferential surface of the pipe installation component 10, inclination portions 23 are arranged, which are inclined toward the electric wire insertion holes 15 from the protection portion 11. The inclination portions 23 are inclined gradually outward from the inner circumferential surface covering portion 19 in the diameter direction as they approach the electric wire insertion holes 15. The inclination portions 23 are arranged at both end portions of the electric wire seal portion 13 in a width direction, corresponding to the pair of electric wire insertion holes 15.

The protection portion 11 in this embodiment is constituted so as to protrude outward in the diameter direction, in a stepped manner. Both end surfaces 11A of the protection portion 11 in the axial direction extend in a direction crossing the longitudinal axis of the pipe installation component 10. The end surface 11A of the projection portion 11 on the electric wire seal portion 13 side may be substantially perpendicular to the longitudinal axis of the pipe installation component 10.

A tape T may be wound about the outer circumferential surfaces of the electric wires W and around the electric wire seal portion 13. The tape T may be wound about the electric wire seal portion 13 to a position close to one of the end surfaces 11A of the protection portion 11. The tape T may be wound about the entire circumference of the electric wires W, and about the entire circumference of the electric wire seal portion 13.

At the outer circumferential surface of the pipe seal portion 14, a fixing member F for fixing the pipe installation component 10 to the end portion of the pipe 30 is attached. Various types of fixing members can be used for the fixing member F; it can be, for example, a tape wound from the pipe 30 to the pipe seal portion 14, a caulking ring that is caulked to the pipe seal portion 14, a binding band that is tightened to the pipe seal portion 14, or the like. The fixing member F is fixed to the pipe installation component 10 more toward the pipe 30 side than toward the nearest end surface 11A of the protection portion 11. The pipe seal portion 14 is held by the fixing member F so as to strongly seal to the end portion of the pipe 30.

The following explains an example of an operation that installs the pipe installation component 10 of this embodiment at the end portion of the pipe 30.

First, the pipe seal portion 14 of the pipe installation component 10 is caused to cover the end portion of the pipe 30, the pipe installation component 10 is drawn to the pipe 30 side, and the end portion of the pipe 30 is fit into the groove portion 22. Upon doing so, the pipe seal portion 14 and the protection portion 11 are engaged to the end portion of the pipe 30. At this time, an interior end surface (covering surface 18A) of the groove portion 22 abuts the end surface 31 of the pipe 30.

Next, the pipe seal portion 14 is fixed by the fixing member F to the end portion of the pipe 30. The lip portions 14A of the pipe seal portion 14 are elastically crushed and sealed to the outer circumferential surface of the pipe 30.

Next, the electric wires W are inserted through the pipe 30. At this time, the end surface 31 of the pipe 30 is covered by the protection portion 11, so the electric wires W are inserted through the pipe 30 without contacting the edge of the pipe 30. Terminal portions of the electric wires W are inserted to the inside of the pipe installation component 10 from the pipe seal portion 14 side, are guided to the inclination portions 23, are inserted through the electric wire insertion ho les 15 from the protection portion 11, and are caused to extend to the outside. The lip portions 13A of the respective electric wire insertion holes 15 are sealed to the respective outer circumferential surfaces of the electric wires W.

Next, the tape T is wound around the electric wire seal portion 13 and around the electric wires W.

Thus, an operation is completed in which the pipe installation component 10 is attached to the end portion of the pipe 30. In such a state in which the pipe installation component 10 is attached to the end portion of the pipe 30, the end surface 31 of the pipe 30 is covered by the protection portion 11, so it is possible to suppress the electric wires W from contacting the edge of the pipe 30 due to vibration or the like.

Next, an operation and effects of the embodiment that is thus constituted are explained.

The pipe installation component 10 of this embodiment is constituted by (i) the protection portion 11 that covers the end surface 31 of the pipe 30, and (ii) the waterproofing portion 12 that has the electric wire insertion holes 15 that seal to the respective outer circumferential surfaces of the electric wires W inserted through the pipe 30. The waterproofing portion seals to an entire circumference of the end portion of the pipe 30, and seals the end portion of the pipe 30.

According to this structure, even if the edge of the pipe 30 is sharp, the protection portion 11 can suppress the electric wires W from contacting the edge of the pipe 30, so it is possible to avoid damage to the coverings of the electric wires W before it happens. Additionally, the waterproofing portion 12 can suppress water from entering the inside of the pipe 30. Thus, it is possible to suppress water from freezing in the pipe 30 at a low temperature after water enters the inside of the pipe 30, so as not to damage the coverings of the electric wires W or the like. Thus, the use of only one component can protect the electric wires W and waterproof the pipe 30.

Furthermore, in this embodiment, the protection portion 11 is provided with (i) the inner circumferential surface covering portion 19 that covers the inner circumferential surface of the end portion of the pipe 30 and (ii) the outer circumferential surface covering portion 21 that covers the outer circumferential surface of the end portion of the pipe 30. According to this structure, not only the end surface 31 of the pipe 30, but also the outer and inner circumferential surfaces of the pipe 30 are covered by the protection portion 11. Thus, it can more reliably suppress the electric wires W from contacting the edge of the pipe 30.

Additionally, the protection portion 11 forms a tubular shape that can be externally engaged to the end portion of the pipe 30, the protection portion 11 and the electric wire insertion holes 15 are arranged so as to be shifted relative to each other in the axial direction, and the inclination portions 23 are arranged, which are inclined toward the electric wire insertion holes 15 from the protection portion 11. According to this structure, an operation can be easily performed in which the electric wires W are inserted through the electric wire insertion holes 15.

Furthermore, the protection portion 11 is constituted so as to protrude; outward in a diameter direction, in a stepped manner. According to this structure, both end surfaces 11A of the protection portion 11 in the axial direction can he used as references for installation positions of fixing members that fix together (i) the pipe installation component 10 and the pipe 30 and/or (ii) the pipe installation component 10 and the electric wires W.

### Other Embodiments

This invention is not limited to the above embodiments that were explained by the description and drawings, and for example, the following embodiments are also included in the technical scope of this invention.
(1) According to the above embodiments, the protection portion 11 is provided with the inner circumferential surface covering portion 19 that covers the inner circumferential surface of the end portion of the pipe 30. However, the protection portion is not limited to this. The protection portion can also be provided without having the inner circumferential surface covering portion.
(2) According to the above embodiments, the pipe installation component 10 accommodates two electric wires W, but the pipe installation component is not limited to this. The pipe installation component can also accommodate one electric wire only, or three electric wires or more (that is, the number of the electric wire insertion holes may be different from that of the above embodiments).
(3) In the above embodiments, the protection portion 11 protrudes outward in a diameter direction, in a stepped manner, but the protection portion is not limited to this. The outer circumferential surface of the protection portion can be continuous with the outer circumferential surface of the pipe seal portion or the outer circumferential surface of the electric wire seal portion, without a step.
(4) In the above embodiments, the electric wires W are inserted through the pipe 30 after installing the pipe installation component 10 at the end portion of the pipe 30, but the sequence is not limited to this. The pipe installation component can be installed at the end portion of the pipe after inserting the electric wires through the pipe, and/or after inserting the electric wires W through the electric wire insertion holes.
(5) In the above embodiments, a case was explained in which the pipe installation component 10 is installed at the end portion of the metal pipe 30, but the structure is not limited to this. The pipe installation component can also be installed at the end portion of a resin pipe.
(6) According to the above embodiments, the protection portion 11 and the electric wire insertion holes 15 are arranged so as to be shifted relative to each other in the axial direction, but the structure is not limited to this. The protection portion and the electric wire insertion holes do not need to be shifted relative to each other in the axial direction. That is, the electric wire insertion holes can also be arranged in the inside of the inner circumferential surface covering portion of the protection portion.

### EXPLANATION OF THE SYMBOLS

W Electric wires
10 Pipe installation component
11 Protection portion
12 Waterproofing portion
15 Electric wire insertion holes
18 End surface covering portion
19 Inner circumferential surface covering portion
21 Outer circumferential surface covering portion
23 Inclination portions
30 Pipe
31 End surface

What is claimed is:

1. A pipe installation component, comprising:
a protection portion that covers an end surface of a pipe; and
a waterproofing portion that (i) has an electric wire insertion hole that seals to an outer circumferential surface of an electric wire inserted through the pipe, (ii) seals to an entire circumference of an end portion of the pipe, and (iii) seals the end portion of the pipe.

2. The pipe installation component as set forth in claim 1, wherein:
the protection portion is provided with (i) an inner circumferential surface covering portion that covers an inner circumferential surface of the end portion of the pipe and (ii) an outer circumferential surface covering portion that covers an outer circumferential surface of the end portion of the pipe.

3. The pipe installation component as set forth in claim 2, wherein:
the protection portion forms a tubular shape that can be engaged to the end portion of the pipe,
the protection portion and the electric wire insertion hole are arranged so as to be shifted relative to each other in an axial direction, and
an inclination portion is arranged, which is inclined toward the electric wire insertion hole from the protection portion.

4. The pipe installation component as set forth in claim 3, wherein the protection portion protrudes outward in a diameter direction, in a stepped manner.

5. The pipe installation component as set forth in claim 2, wherein the protection portion protrudes outward in a diameter direction, in a stepped manner.

6. The pipe installation component as set forth in claim 1, wherein the protection portion. protrudes outward in a diameter direction, in a stepped manner.

7. The pipe installation component as set forth in claim 1, wherein the waterproofing portion includes a sealing lip that protrudes inward in a diameter direction and seals to the outer circumferential surface of the electric wire.

8. The pipe installation component as set forth in claim 1, wherein the waterproofing portion includes a sealing lip that protrudes inward in a diameter direction and seals to the outer circumferential surface of the pipe.

9. The pipe installation component as set forth in claim 1, wherein the electric wire insertion hole comprises a plurality of electric wire insertion holes.

10. A structure of an end portion of a pipe, comprising:
a pipe; and
the pipe installation component as set forth in claim 1, installed at the end portion of the pipe.

11. The structure as set forth in claim 10, wherein the pipe is a metal pipe.

12. The structure as set forth in claim 10, further comprising an electric wire inserted through the pipe and through the electric wire insertion hole of the waterproofing portion.

13. The structure as set forth in claim 12, wherein the electric wire is part of a wire harness of a vehicle.

14. The structure as set forth in claim 10, wherein the electric wire insertion hole of the waterproofing portion comprises a plurality of electric wire insertion holes, the structure further comprising a plurality of electric wires inserted through the pipe and through respective ones of the electric wire insertion holes.

15. The structure as set forth in claim 14, wherein the electric wires are part of a wire harness of a vehicle.
